(19) United States
(12) Patent Application Publication
(10) Pub. No.: US 2026/0138246 A1
(43) Pub. Date: May 21, 2026

(54) TORQUE TOOL

(71) Applicants: WEN-JIN GUO, Taichung City (TW); OGC TORQUE CO., LTD., Taichung City (TW)

(72) Inventor: WEN-JIN GUO, Taichung City (TW)

(21) Appl. No.: 19/336,969

(22) Filed: Sep. 23, 2025

(30) Foreign Application Priority Data
Nov. 19, 2024 (TW) 113144397

(51) Int. Cl. B25B 23/14; B25B 23/145

(52) U.S. Cl. CPC B25B 23/141; B25B 23/145

(57) ABSTRACT

A torque tool is provided, wherein the torque tool includes: a main body including first and second tubes; a drive portion disposed on the second tube, the drive portion slipping when receiving a torque greater than a predetermined torque value; a torque adjustment mechanism configured to adjust the predetermined torque value; a handle assembled to and rotatable with the torque adjustment mechanism to drive the torque adjustment mechanism, and including slots; and a positioning mechanism including a slidable sleeve sleeved on the main body and the handle, and at least one positioning element, the slidable sleeve including a receiving portion and an urging portion; wherein the urging portion is configured to urge the at least one positioning element to engage within one slot so that the handle is not rotatable, or disengages from the at least one positioning element so that the handle is rotatable.

### BACKGROUND OF THE INVENTION

### Field of the Invention

The present invention relates to a driving tool, particularly to a torque tool.

### Description of the Prior Art

A conventional torque tool, such as one disclosed in TW I542450, adjusts a torque value by a torque adjustment cap located at an end of a gripping handle to change a position of a sliding block.

However, the torque adjustment cap is normally urged outward by an urging spring so that inner and outer ratchet rings of the gripping handle and the torque adjustment cap are engaged. During torque adjustment, the torque adjustment cap must be pressed inward so that the inner and outer ratchet rings of the gripping handle and the torque adjustment cap are disengaged, and then the torque adjustment cap can be rotated to adjust the torque value. Therefore, continuous inward pressing of the torque adjustment cap is required while rotating to adjust torque, which requires simultaneous application of forces in different directions, and a hand can grip only a small area of the torque adjustment cap, which makes operation difficult.

The present invention is, therefore, arisen to obviate or at least mitigate the above-mentioned disadvantages.

### SUMMARY OF THE INVENTION

The main object of the present invention is to provide a torque tool that enables a slidable sleeve to be controlled to lock a handle in position, or to unlock the handle so that the handle is rotatable relative to a main body to adjust torque, thereby providing ease of operation.

To achieve the above and other objects, a torque tool is provided, wherein the torque tool includes: a main body including a first tube and a second tube assembled to each other, the first tube including at least one through hole, the second tube including a receiving space; a drive portion disposed on the second tube, the drive portion slipping when a torque applied to the drive portion is greater than a predetermined torque value; a torque adjustment mechanism disposed in the receiving space and axially movable relative to the main body to adjust the predetermined torque value; a handle rotatable relative to the main body, and assembled to and rotatable with the torque adjustment mechanism to drive the torque adjustment mechanism to move axially relative to the main body, an outer surface of the handle including a plurality of slots; and a positioning mechanism including a slidable sleeve and at least one positioning element, the slidable sleeve being sleeved on the main body and the handle and movable between a locked position and a released position, the slidable sleeve including a receiving portion and an urging portion, the at least one positioning element being received in the at least one through hole and located between the slidable sleeve and the handle; wherein when the slidable sleeve is at the locked position, the urging portion urges the at least one positioning element to engage within the at least one of the plurality of slots so that the handle is not rotatable relative to the main body, and when the slidable sleeve is at the released position, the urging portion does not urge the at least one positioning element, the at least one positioning element is disengageable from the at least one slot and at least partially received in the receiving portion so that the handle is rotatable relative to the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a schematic view showing the slidable sleeve at a locked position in an exemplary embodiment of the present invention;

FIG. 4 is a schematic view showing the slidable sleeve at a released position in an exemplary embodiment of the present invention;

FIG. 5 is a schematic view showing rotation of the handle in an exemplary embodiment of the present invention;

FIG. 6 is a radial cross-sectional view of an exemplary embodiment of the present invention; and

FIG. 7 is a cross-sectional view of an exemplary embodiment of the present invention.

### DETAILED DESCRIPTION OF THE PREFERRED EMBODIMENTS

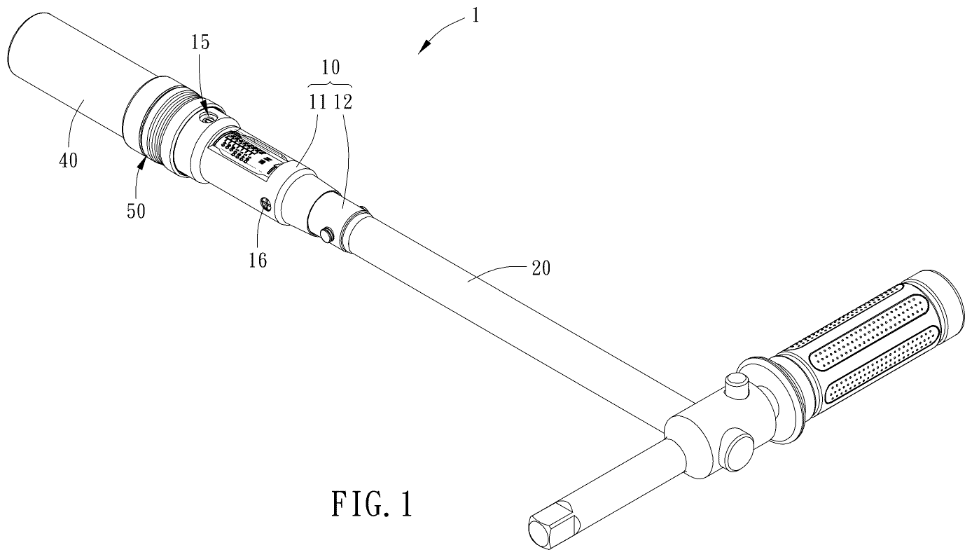

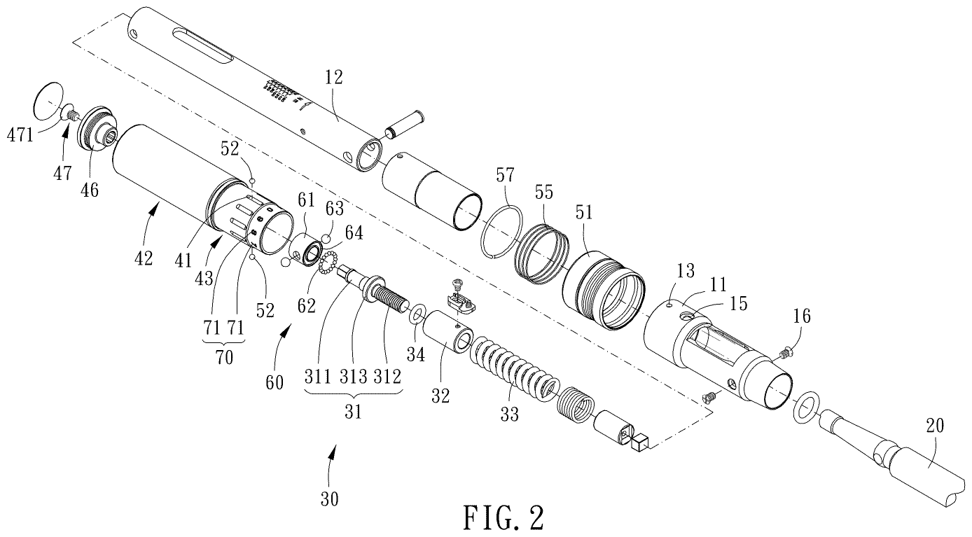

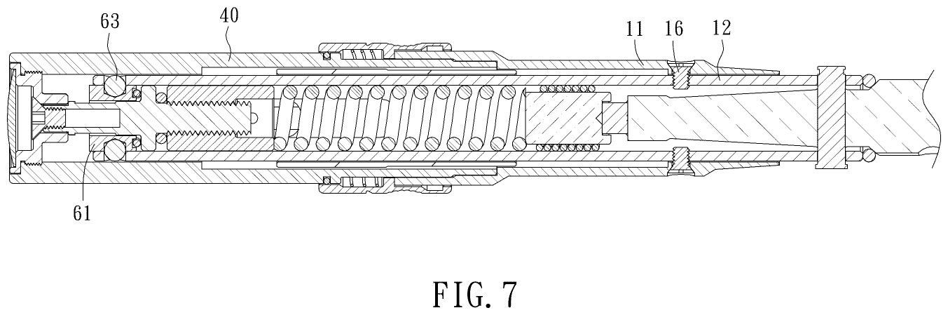

Please refer to FIGS. 1 to 7 for an exemplary embodiment of the present invention. A torque tool 1 of the present invention includes a main body 10, a drive portion 20, a torque adjustment mechanism 30, a handle 40, and a positioning mechanism 50.

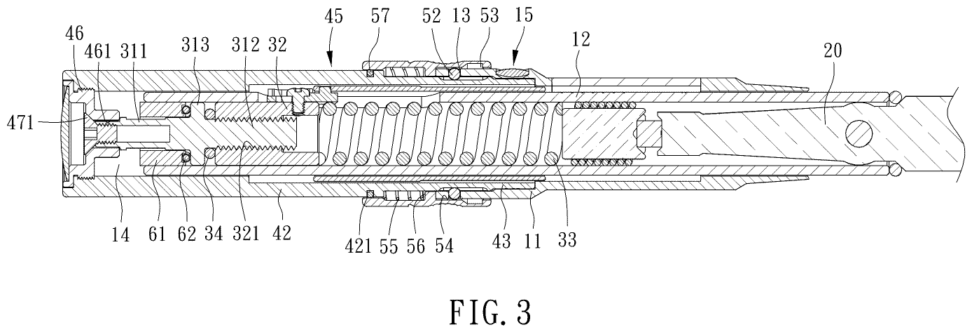

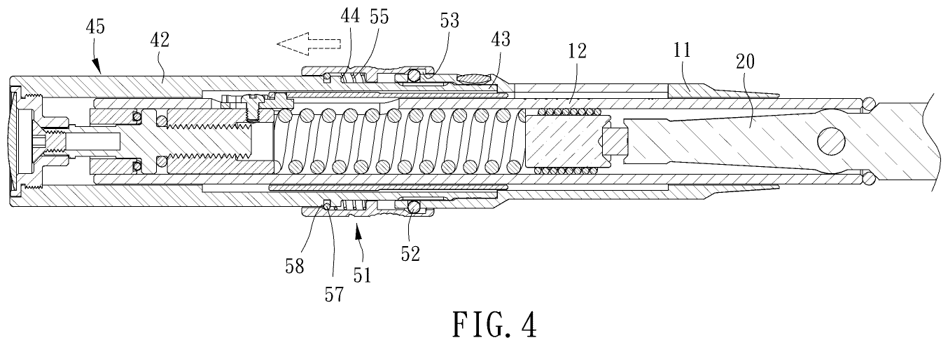

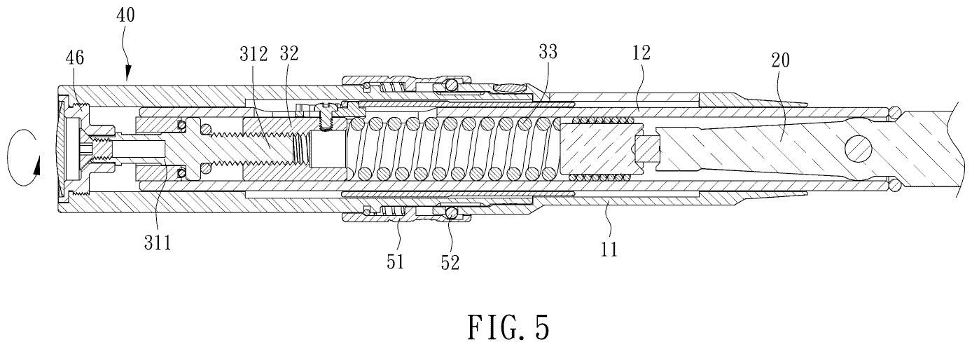

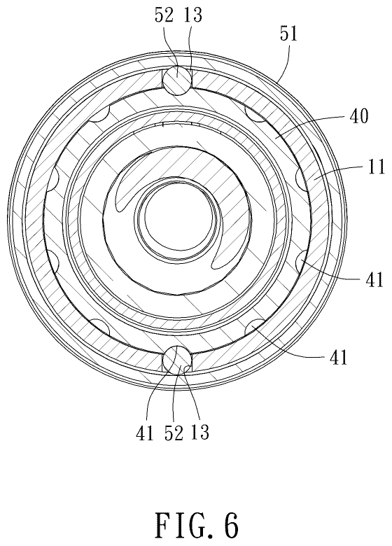

The main body 10 includes a first tube 11 and a second tube 12 connected to each other. The first tube 11 includes at least one through hole 13, and the second tube 12 includes a receiving space 14. In this embodiment, the first tube 11 is sleeved on the second tube 12, and the first tube 11 and the second tube 12 are connected by at least one connecting member 16 disposed therethrough so as to be non-rotatable relative to each other. Each connecting member 16 is a threaded fastener or may be a pin. The drive portion 20 is disposed on the second tube 12, and the drive portion 20 slips when a torque applied to the drive portion 20 is greater than a predetermined torque value. The torque adjustment mechanism 30 is disposed in the receiving space 14 and is axially movable relative to the main body 10 to adjust the predetermined torque value. The handle 40 is rotatably relative to the main body 10 and is assembled to and rotatable with the torque adjustment mechanism 30 to drive the torque adjustment mechanism 30 to move axially relative to the main body 10. An outer surface of the handle 40 includes a plurality of slots 41. The positioning mechanism 50 includes a slidable sleeve 51 and at least one positioning element 52 (in this embodiment being a ball). The slidable sleeve 51 is sleeved on the main body 10 and the handle 40 and is movable between a locked position (see FIGS. 3 and 6) and a released position (see FIGS. 4 and 5). The slidable sleeve 51 includes a receiving portion 53 and an urging portion 54 (which may be an annular contact surface). The at least one positioning element 52 is received in the at least one through hole 13 and is located between the slidable sleeve 51 and the handle 40.

In practice, when the slidable sleeve 51 is at the locked position (see FIGS. 3 and 6), the urging portion 54 urges the at least one positioning element 52 to engage within at least one of the slots 41 so that the handle 40 is not rotatable relative to the main body 10, thereby fixing the predetermined torque value. When the slidable sleeve 51 is at the released position (see FIGS. 4 and 5), the urging portion 54 does not urge the at least one positioning element 52, the at least one positioning element 52 is disengageable from at least one of the slots 41 and is at least partially received in the receiving portion 53 so that the handle 40 is rotatable relative to the main body 10 to adjust the predetermined torque value.

Preferably, the plurality of slots 41 are circumferentially spaced on the outer surface of the handle 40. The first tube 11 includes a plurality of through holes 13. The positioning mechanism 50 includes a plurality of positioning elements 52, and the plurality of positioning elements 52 are received in the plurality of through holes 13, thereby providing a plurality of torque adjustment stages and enabling stable positioning at the predetermined torque value.

By switching a position of the slidable sleeve 51 to lock or to release the handle 40, the handle 40 can be rotated to adjust the predetermined torque value when the handle 40 is released. A hand can grip a large area of the handle 40 for operation, which is convenient. In addition, disposing the plurality of slots 41 on the outer surface of the handle 40 not only facilitates machining but, because an outer diameter of the handle 40 is larger, also provides more torque adjustment stages and allows the first tube 11 and the second tube 12 to include more structures (such as a torque indicating structure to indicate the predetermined torque value, but not limited thereto).

The handle 40 includes a large diameter section 42, a small diameter section 43, and a shoulder 44 formed between the large diameter section 42 and the small diameter section 43. The positioning mechanism 50 further includes a spring 55. The first tube 11 is rotatably sleeved on the small diameter section 43. The slidable sleeve 51 has a blocking flange 56. The spring 55 is resiliently disposed between the shoulder 44 and the blocking flange 56. The blocking flange 56 is axially engageable with the first tube 11. The plurality of slots 41 are disposed on the small diameter section 43. Preferably, the large diameter section 42 includes an annular recess 421. The positioning mechanism 50 further includes a retainer 57. The retainer 57 is engaged in the annular recess 421 and is elastically expandable radially outward to press against an inner wall of the slidable sleeve 51. The retainer 57 has a gap so that it can radially expand and be compressed, and frictional force can be generated by the retainer 57 radially pressing against the slidable sleeve 51. An inner side of the slidable sleeve 51 includes a stop flange 58. When the slidable sleeve 51 is at the released position, the stop flange 58 axially blocks the retainer 57 (see FIG. 4), and the stop flange 58 protrudes radially toward an inner diameter of the slidable sleeve 51. As such, the hand need not continuously apply force, and the slidable sleeve 51 can be positioned at the released position. By merely moving the slidable sleeve 51 toward the locked position, the retainer 57 can be radially compressed to release limiting of the slidable sleeve 51, allowing the slidable sleeve 51 to elastically return to the locked position.

The torque tool 1 further includes a lubrication assembly 60. The lubrication assembly 60 is disposed in the receiving space 14. The lubrication assembly 60 includes a sleeve member 61 and a plurality of balls 62. The torque adjustment mechanism 30 includes a shaft 31, an abutting member 32 and an elastic member 33. The elastic member 33 is resiliently disposed between the drive portion 20 and the abutting member 32. The shaft 31 includes an assembling end portion 311, a threaded end portion 312 and an annular flange 313. The assembling end portion 311 passes through the sleeve member 61 and is assembled to the handle 40. The threaded end portion 312 is screwed to a threaded structure 321 of the abutting member 32. The handle 40 is configured to drive the shaft 31 to rotate relative to the main body 10 so that the abutting member 32 is movable relative to the threaded end portion 312 to axially press the elastic member 33 to adjust the predetermined torque value. The annular flange 313 is disposed between the assembling end portion 311 and the threaded end portion 312, and the plurality of balls 62 are disposed between the annular flange 313 and the sleeve member 61. Preferably, the sleeve member 61 has, at an end toward the abutting member 32, an annular groove 64 in which the plurality of balls 62 are rollably engaged. Thus, the annular flange 313 can press against the plurality of balls 62 to rotate smoothly relative to the sleeve member 61. In addition, the lubrication assembly 60 includes a plurality of connectors 63. The connectors 63 are connected to the second tube 12 and the sleeve member 61 so that the sleeve member 61 is non-rotatable relative to the second tube 12. Each connector 63 may be a steel ball or may be a pin. Specifically, the plurality of connectors 63 are received in a plurality of circumferentially spaced recesses of the sleeve member 61 and a plurality of circumferentially spaced hole structures of the second tube 12 to facilitate assembly.

Specifically, the handle 40 includes a grip 45, a cover 46 and a locking element 47. The grip 45 is sleeved on the second tube 12. The cover 46 is disposed to cover an end of the grip 45. The assembling end portion 311 passes through a perforation 461 of the cover 46. The locking element 47 passes through the perforation 461 to lock the assembling end portion 311. A head portion 471 of the locking element 47 engages with the cover 46 in a direction toward the assembling end portion 311. The assembling end portion 311 and the cover 46 are assembled to rotate with each other, for example by a polygonal engagement, which facilitates assembly and enables the grip 45 to drive the assembling end portion 311 to rotate.

The torque adjustment mechanism 30 further includes a spacer 34. The spacer 34 is disposed on the threaded end portion 312 and is located between the annular flange 313 and the abutting member 32. The spacer 34 is annular and is used to separate the annular flange 313 and the abutting member 32 to prevent them from abutting each other, thereby enabling the shaft 31 and the abutting member 32 to rotate smoothly relative to each other. In addition, the spacer 34 can also stop the abutting member 32 from continuing to move toward the annular flange 313 to avoid the abutting member 32 and the annular flange 313 from abutting and sticking. Further, it can prevent the abutting member 32 from moving excessively and becoming stuck on a non-threaded section of the shaft 31, which would make movement difficult.

The outer surface of the handle 40 includes a first scale structure 70. The first scale structure 70 includes a plurality of marking portions 71 configured to indicate different torque values, and the plurality of marking portions 71 axially correspond to the plurality of slots 41. Specifically, the first tube 11 includes a first window 15. The first tube 11 is sleeved on the handle 40, and the first window 15 corresponds to at least one of the marking portions 71. The first window 15 includes an opening of the first tube 11 and a light-penetrable plate. Thus, when the handle 40 is rotated to adjust torque, at least one of the marking portions 71 can be viewed through the first window 15 to quickly check the adjusted predetermined torque value.

In summary, in the torque tool of the present invention, by switching a position of the slidable sleeve 51 to lock or to release the handle 40, steps for quickly adjusting torque can be performed. Moreover, the structural feature of disposing the plurality of slots 41 on the outer surface of the handle 40 facilitates reduction of machining difficulty and reduction of manufacturing cost.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torque tool including:
a main body including a first tube and a second tube assembled to each other, the first tube including at least one through hole, the second tube including a receiving space;
a drive portion disposed on the second tube, the drive portion slipping when a torque applied to the drive portion is greater than a predetermined torque value;
a torque adjustment mechanism disposed in the receiving space and axially movable relative to the main body to adjust the predetermined torque value;
a handle rotatable relative to the main body, and assembled to and rotatable with the torque adjustment mechanism to drive the torque adjustment mechanism to move axially relative to the main body, an outer surface of the handle including a plurality of slots; and
a positioning mechanism including a slidable sleeve and at least one positioning element, the slidable sleeve being sleeved on the main body and the handle and movable between a locked position and a released position, the slidable sleeve including a receiving portion and an urging portion, the at least one positioning element being received in the at least one through hole and located between the slidable sleeve and the handle;
wherein when the slidable sleeve is at the locked position, the urging portion urges the at least one positioning element to engage within the at least one of the plurality of slots so that the handle is not rotatable relative to the main body, and when the slidable sleeve is at the released position, the urging portion does not urge the at least one positioning element, the at least one positioning element is disengageable from the at least one slot and at least partially received in the receiving portion so that the handle is rotatable relative to the main body.

2. The torque tool of claim 1, wherein the plurality of slots are circumferentially spaced on the outer surface of the handle, the at least one through hole includes a plurality of through holes, the at least one positioning element includes a plurality of positioning elements, and the plurality of positioning elements are received in the plurality of through holes.

3. The torque tool of claim 1, wherein the handle includes a large diameter section, a small diameter section and a shoulder between the large diameter section and the small diameter section, the positioning mechanism further includes a spring, the first tube is non-rotatably sleeved on the small diameter section, the slidable sleeve has a flange, the spring is resiliently disposed between the shoulder and the flange, the flange is axially engageable with the first tube, and the plurality of slots are disposed on the small diameter section.

4. The torque tool of claim 3, wherein the large diameter section includes an annular recess, the positioning mechanism further includes a retainer, the retainer is engaged in the annular recess and is elastically expandable radially outward to press against an inner wall of the slidable sleeve, an inner side of the slidable sleeve includes a stop flange, and when the slidable sleeve is at the released position, the stop flange axially blocks the retainer.

5. The torque tool of claim 1, further including a lubrication assembly disposed in the receiving space, wherein the lubrication assembly includes a sleeve member and a plurality of balls, the torque adjustment mechanism includes a shaft, an abutting member and an elastic member, the elastic member is resiliently disposed between the drive portion and the abutting member, the shaft includes an assembling end portion, a threaded end portion and an annular flange, the assembling end portion passes through the sleeve member and is assembled to the handle, the threaded end portion is screwed to a threaded structure of the abutting member, the handle is configured to drive the shaft to rotate relative to the main body so that the abutting member is movable relative to the threaded end portion to axially press the elastic member to adjust the predetermined torque value, the annular flange is disposed between the assembling end portion and the threaded end portion, and the plurality of balls are disposed between the annular flange and the sleeve member.

6. The torque tool of claim 5, wherein the lubrication assembly includes a plurality of connectors, and the connectors is connected to the second tube and the sleeve member so that the sleeve member is non-rotatable relative to the second tube.

7. The torque tool of claim 5, wherein the torque adjustment mechanism further includes a spacer disposed on the threaded end portion and located between the annular flange and the abutting member.

8. The torque tool of claim 1, wherein the outer surface of the handle includes a first scale structure, the first scale structure includes a plurality of marking portions configured to indicate different torque values, and the plurality of marking portions axially correspond to the plurality of slots.

9. The torque tool of claim 8, wherein the first tube includes a first window, the first tube is sleeved on the handle, and the first window corresponds to at least one of the plurality of marking portions.

10. The torque tool of claim 5, wherein the first tube and the second tube are connected by at least one connecting member disposed therethrough so as to be non-rotatable relative to each other; the sleeve member has, at an end toward the abutting member, an annular groove in which the plurality of balls are rollably engaged; the plurality of slots are circumferentially spaced on the outer surface of the handle, the at least one through hole includes a plurality of through holes, the at least one positioning element includes a plurality of positioning elements, and the plurality of positioning elements are received in the plurality of through holes; the handle includes a large diameter section, a small diameter section and a shoulder between the large diameter section and the small diameter section, the positioning mechanism further includes a spring, the first tube is rotatably sleeved on the small diameter section, the slidable sleeve has a flange, the spring is resiliently disposed between the shoulder and the flange, the flange is axially engageable with the first tube, and the plurality of slots are disposed on the small diameter section; the large diameter section includes an annular recess, the positioning mechanism further includes a retainer, the retainer is engaged in the annular recess and is elastically expandable radially outward to press against an inner wall of the slidable sleeve, an inner side of the slidable sleeve protrudingly includes a stop flange, and when the slidable sleeve is at the released position, the stop flange axially blocks the retainer; the torque adjustment mechanism further includes a spacer disposed on the threaded end portion and located between the annular flange and the abutting member; the outer surface of the handle includes a first scale structure, the first scale structure includes a plurality of marking portions configured to indicate different torque values, and the plurality of marking portions axially correspond to the plurality of slots; the first tube includes a first window, the first tube is sleeved on the handle, and the first window corresponds to at least one of the plurality of marking portions; the handle includes a grip, a cover and a locking element, the grip is sleeved on the second tube, the cover is disposed to cover an end of the grip, the assembling end portion passes through a perforation of the cover, the locking element passes through the perforation to lock the assembling end portion, and a head portion of the locking element engages with the cover in a direction toward the assembling end portion.
